(19) United States
(12) Patent Application Publication
(10) Pub. No.: US 2009/0019161 A1
(43) Pub. Date: Jan. 15, 2009

(54) HYBRID EPG SERVER WITH SERVICE DISPATCHER TO BUILD A DISPATCHER REDUNDANCY CHAIN IN CLUSTERED IPTV EPG SERVICE

(75) Inventors: Qiang Li, Saratoga, CA (US); Huiyou Zhu, Fremont, CA (US); Chen Ma, Fremont, CA (US); Naxin Wang, Cupertino, CA (US)

Correspondence Address: UTSTARCOM, INC.;c/o Laura Weiss, Paralegal, 3800 Golf Road, Suite 220, Rolling Meadows, IL, 60008, US

(73) Assignee: UTSTARCOM, INC., Alameda, CA (US)

(21) Appl. No.: 11/776,766

(22) Filed: Jul. 12, 2007

(51) Int. Cl. G06F 15/173

(52) U.S. Cl. 709/226

(57) ABSTRACT

An EPG service architecture incorporates multiple EPG servers connected in a cluster with each EPG server having an EPG service module and a dispatcher. Each dispatcher has the capability for state determination as an active or standby dispatcher. A plurality of STBs interface with the EPG server cluster and issue requests for EPG service which are routed by the active dispatcher. The routing is accomplished by redirection of the request to an EPG service module selected from the multiple EPG servers in the cluster. Each EPG service module includes the capability for service connection to the STB upon receiving the redirection from the active dispatcher. Upon a determination that the current active dispatcher is not operating, the standby dispatchers vote for a replacement which then assumes the active dispatcher role.

### BACKGROUND OF THE INVENTION

1. Field of the Invention

This invention relates generally to the field of Electronic Program Guide (EPG) servers for Internet Protocol Television (IPTV) service and more particularly to an architecture and method to establish dispatcher redundancy for clustered IPTV EPG servers.

2. Related Art

Traditionally, when EPG servers are clustered to provide greater service capability, two forms of key components are employed; a dispatcher for service request redirecting and real servers consuming service request.

Normally, a dispatcher is a piece of standalone and dedicated hardware or software connected to the clustered EPG servers. Alternatively, failure redundancy is provided by two dispatchers in a simple active-standby mechanism. Thus, the dispatcher can be a single point failure to clustered EPG service if the dispatcher in the single device application or one or both dispatchers in the active-standby system failed to act. As a result of such failure, no EPG service handling is provided in response to request.

It is therefore desirable to configure EPG servers within a clustered EPG service platform with service dispatch capability that will maximally reduce single point failure to EPG service.

### SUMMARY OF THE INVENTION

The present invention provides an EPG service architecture which incorporates multiple EPG servers connected in a cluster with each EPG server having an EPG service module and a dispatcher. Each dispatcher has the capability for state determination an an active or standby dispatcher. A plurity of STBs interface with the EPG server cluster and issue requests for EPG service which are routed by the active dispatcher. The routing is accomplished by redirection of the request to an EPG service module selected from the multiple EPG servers in the cluster. Each EPG service module includes the capability for service connection to the STB upon receiving the redirection from the active dispatcher. Upon a determination that the current active dispatcher is not operating, the standby dispatchers vote for a replacement which then assumes the active dispatcher role.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of an exemplary embodiment of an exemplary embodiment of an EPG cluster employing the present invention;

FIG 2. is a block diagram showing functional flow of data requests and response;

FIG. 3 is a state chart of the probe function in the exemplary embodiment;

FIG. 4 is a state chart of the heart beat function by the active dispatcher;

FIG. 5 is a state chart of the standby state activity for stanby dispatchers;

FIG. 6 is a state chart of the race state by standby dispatchers to become the new active dispatcher upon failure of the current active dispatcher.

### DETAILED DESCRIPTION OF THE INVENTON

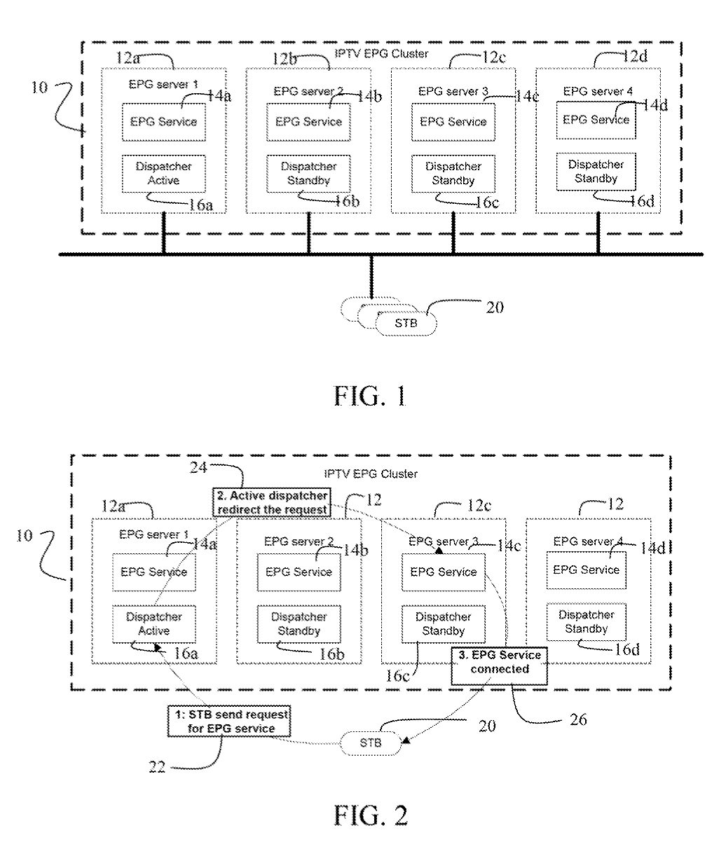

FIG. 1 shows an embodiment incorporating the present invention having a cluster 10 with a plurity of EPG servers 12a-12d, wherein each EPG server includes an EPG service module 14a-14d and service dispatcher module 16a-16d. The EPG server includes the functions of a web server, EPG database and backend module in communication with a backend service module such as authentication, billing or/and subscriber manager. The service dispatcher functions to dispatch incoming IP based requests to a selected EPG service module within cluster, based on a pre-defined algorithm. Multiple set top boxes (STB) 18 for individual users of the EPG are connected to the cluster for EPG service. In the embodiment shown, one dispatcher will assume an “in action” state to be the active dispatcher while the other dispatchers remain in a standby condition.

As shown in FIG. 2 for normal operation, a STB 18 sends a request for EPG service 20 which is redirected 22 by the active dispatcher 16a. For the example shown, the request is redirected to server 12c and the EPG service module 14c is connected 24 to the STB for data exchange. Service dispatching is a process consisting of using a connection hash table located and maintained in the active dispatcher in combination with a workload algorithm to route incoming service requests from user STBs to an appropriate EPG server. For an exemplary embodiment the algorithm is a variation of a Least Recently Used (LRU) algorithm. For each incoming STB request, the dispatcher will access the connection hash table and handle the redirection in two steps. First, if the request is from currently active STB, the request will be forward to pre-assigned assigned server for service continuation. Alternatively, if the request is from an unknown STB, the dispatch will look up the least busy server based on current server connection counter and forward the STB request to that server and flag the STB as active. The algorithm will intercept the TCP FIN flag for each connected EPG service session and update connection hash table for the current server connection counter.

In the present invention, each dispatcher also employs a state machine to initiate, listen, vote, and declare “in action” with respect to the active or standby role.

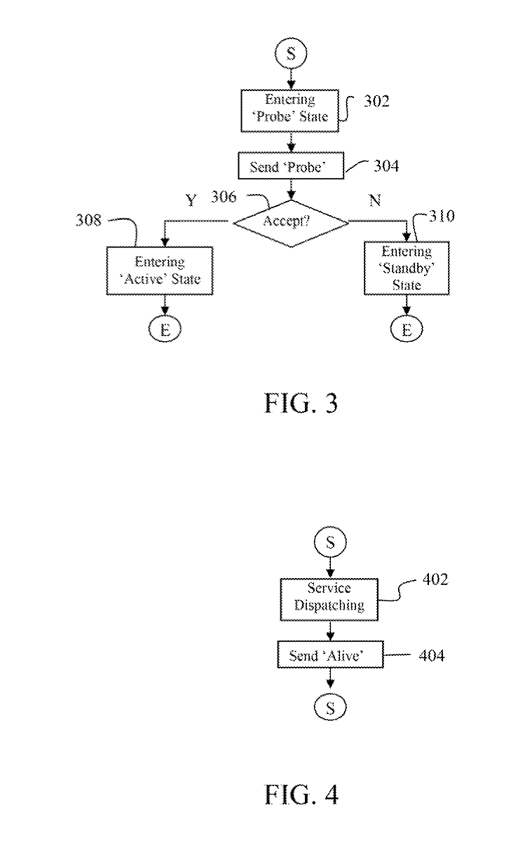

As shown in FIG. 3, upon startup, the dispatcher will enter an initiate mode or probe status 302 and send out a broadcast request or probe 304 to gather other dispatcher status. If there is an accept state 306 with no other dispatcher running, the dispatcher will enter into ‘In Action’ mode 308 and assume control as the active dispatcher. If in response to the probe an “alive” signal is received from a currently active dispatcher as described below, the probing dispatcher enters the standby state 310.

As shown in FIG. 4, the dispatcher in active service the dispatcher will look up the connection hash table and route incoming service request in appropriate EPG server, synchronizing the connection hash table by multicasting 402 to the other dispatchers listening in standby.

The active dispatcher issues an “alive” signal 404, in response to a probe from the standby dispatchers, reflecting its active state.

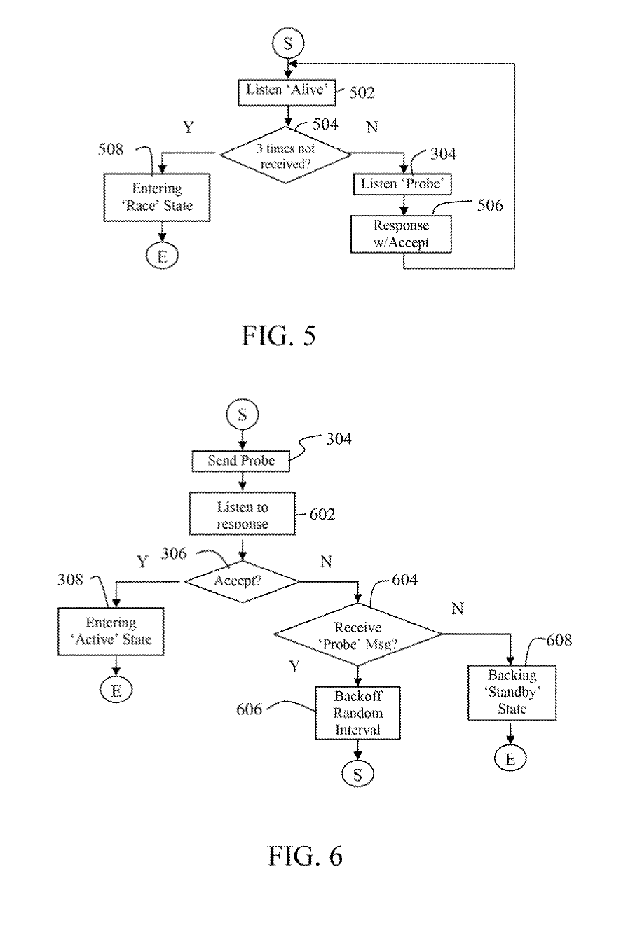

As shown in FIG. 5, if there is an active dispatcher running, each standby dispatcher will enter into ‘Listen’ mode 502. The dispatcher will listen for predetermined periods for an “alive” broadcast 504. If no alive is received, the standby dispatcher will send a probe 304 as described above in the form of a TCP based heartbeat to detect the status of the currently active dispatcher. If a response with accept 504 is received, the standby dispatcher will handle multicast requests from the active dispatcher for connection hash table sync and return to the Listen state. If no Alive″ is received after the third probe 506 the standby dispatcher will enter the race state 508.

In runtime, there is only one active dispatcher providing routing service. If the active dispatcher goes offline, all other dispatchers will fail to receive its heartbeat message. Those remaining dispatchers will enter into ‘Voting’ mode or race state, and elect a new primary dispatcher. FIG. 6 shows the state flow for the exemplary embodiment. In the race state, the standby dispatcher will issue a probe 304. A determination will be made if the probe is accepted 602. If the probe is accepted, the standby dispatcher will proceed to the “active” state 308 and assume the duties as the active dispatcher. If the probe is not accepted, the standby dispatcher will determine if if has received a probe 604. If so, it will delay its probe transmission for a random interval 606 and return to the send probe state. If the standby dispatcher has not received a probe, it will return to the standby state 608.

Without any extra hardware required, each EPG server with a dispatcher constitutes the basis for supporting the multi-level dispatcher redundancy. Because of data synchronization of the connection hash table, all dispatcher within the cluster maintain nearly the same latest connection data. When primary or active dispatcher goes offline, a newly elected dispatcher from any one of EPG servers will take over the routing responsibility seamlessly.

For the service functions described previously with respect to FIG. 2, when dispatcher 16a is down, standby dispatchers 16b, 16c and 16d will vote one to assume the active role, using the processes described. As long as one EPG server with dispatcher is alive, EPG service will not be stopped. This eliminates the potential cluster failure due to a dispatcher double failure when compared to a conventional clustering scenario.

Use of the exemplary embodiment in a real application scenario is accomplished by activating two to four dispatchers within one EPG service cluster as active and standby units. It is not necessary to activate the dispatcher module on each EPG server thereby reducing performance impacts due to the high frequency of data synchronization required among dispatchers as disclosed.

Having now described the invention in detail as required by the patent statutes, those skilled in the art will recognize modifications and substitutions to the specific embodiments disclosed herein. Such modifications are within the scope and intent of the present invention is defined in the following claims.

What is claimed is:

1. An EPG service architecture comprising:
a plurality of EPG servers connected in a cluster with each EPG server having
an EPG service module; and
a dispatcher, each dispatcher having means for state determination as an active dispatcher;
a plurality of STBs interfaced with the EPG server cluster and issuing requests for EPG service;
said active dispatcher having means for routing each request.

2. The EPG service architecture of claim 1 wherein the means for routing comprises means for redirection of the request to an EPG service module selected from the plurality of EPG servers and each EPG service module includes means for service connection to the STB upon receiving the redirection from the active dispatcher.

3. The EPG service architecture of claim 1 wherein the means for state determination includes
means for an initiate mode having
means to send out a probe to gather other dispatcher status;
means to enter into ‘in Action’ mode and assume control as the active dispatcher of no other dispatcher is running; and,
means to enter into a standby mode if an “alive” signal is received from a currently active dispatcher.

4. The EPG service architecture of claim 3 further comprising
means for looking up a connection hash table and route incoming service request to an appropriate EPG server,
means for synchronizing the connection hash table by mulicasting to the other dispatchers listening in standby and,
means for issuing an “alive” signal reflecting its active state, all responsive to the means to enter into the “in action” mode.

5. Tne EPG service architecture of claim 4 wherein the means to enter into a standby mode further comprises:
means for listening for predetermined periods for an “alive” broadcast;
means to send a probe to detect the status of the currently active dispatcher;
means to handle multicast request from primary dispatcher for connection hash tably sync and return to the means for listening responsive to receipt of an alive broadcast by the listening means;
means for a race state responsive to lack of receipt of an alive broadcast by the listening means.

6. The EPG service architecture of claim 5 wherein the “alive” broadcast is in the form a TCP based heartbeat.

7. The EPG service architecture of claim 5 wherein the means for a race state comprises means to determine if the dispatcher has received a probe;
means responsive to receipt of a probe to delay its probe transmissions for random interval and return to the send probe state; and
means to return to the standby state if the dispatcher has not received a probe.

8. A method for EPG service control comprising the steps of:
providing a plurality of EPG servers connected in a cluster with each EPG server having an EPG service module and a dispatcher;
for each dispatcher,
entering into an initiate mode including
sending out a probe to gather other dispatcher status;
entering into ‘In Action’ mode and assuming control as the active dispatcher if no other dispatcher is running; and,
entering into a standby mode if an “alive” signal is received from a currently active dispatcher.

9. The method of claim 8 further comprising the steps of:
looking up a connection hash table and routing incoming service request to an appropriate EPG server,
synchronizing a connection hash table by multicasting to the other dispatchers listening in standby and,
issuing an “alive” signal reflecting its active state, all responsive to the step of entering into the “In Action” mode.

10. The method of claim 8 further comprising the steps of:
listening for predetermined periods for an “alive” broadcast;
sending a probe to detect the status of the currently active dispatcher;
receiving a multicast request from primary dispatcher for connection hash table sync and
returning to the step of listening responsive to receipt of an alive broadcast;
entering a race state responsive a lack of receipt of an alive broadcast in the listening step;
all responsive to entering into the standby mode.

11. The method of claim 10 further within entering into the race state comprises the steps of:
determining if the dispatcher has received a probe;
delaying probe transmissions for a random interval and return to the send probe state responsive to receipt of a probe; and
returning to the standby state if the dispatcher has not received a probe.

12. The method of claim 8 wherein the step of looking up a connection hash table and routing incoming service request to an appropriate EPG server further comprises the steps of:
if the request is from currently active STB, forward the request to a pre-assigned server for service continuation;
alternatively, if the request is from an unknown STB, looking up the least busy server based on current server connection counter, forwarding the STB request to that server and flagging the STB as active; and,
intercepting the TCP FIN flag for each connected EPG service session and updating the connection hash table for the current server connection counter.
